(19) United States
(12) Patent Application Publication
(10) Pub. No.: US 2012/0325858 A1
(43) Pub. Date: Dec. 27, 2012

(54) MODULAR PAINT SPOUT

(75) Inventors: Vance MACDONALD, Calgary (CA); Benjamin LEONARD, Calgary (CA)

(73) Assignee: KOVRD PRODUCTS INC., Calgary (CA)

(21) Appl. No.: 13/465,207

(22) Filed: May 7, 2012

Related U.S. Application Data
(63) Continuation-in-part of application No. 13/166,862, filed on Jun. 23, 2011.

(30) Foreign Application Priority Data
Jun. 23, 2011 (CA) 2744292

(51) Int. Cl. B67D 7/76

(52) U.S. Cl. 222/189.07; 222/568

(57) ABSTRACT

A paint spout is provided comprising: a hollow spout shaft comprising an insertion end and an oppositely disposed pouring end, the insertion end enabled for removable attachable insertion into a hole of a paint container, the pouring end enabled to direct paint pouring, through the hollow spout shaft; a strainer member; and, a strainer retaining portion for enabling a strainer member to be removably retained by the hollow spout shaft such that the paint poured there through is filtered by the strainer member, wherein the strainer member extends from at least one of: the pouring end of the hollow spout shaft; and, the insertion end of the hollow spout shaft.

### CROSS-REFERENCE TO RELATED APPLICATIONS

The present application is a Continuation-in-Part of U.S. patent application Ser. No. 13/166,862 filed Jun. 23, 2011, entitled “Modular Paint Spout” and claims further priority from Canadian Patent Application 2744292, filed on Jun. 23, 2011, each of which are incorporated herein by reference.

### FIELD

The specification relates generally to painting accessories, and specifically to a paint spout.

### BACKGROUND

Five gallon paint containers generally have one of two types of openings: a threaded opening closed by a threaded screw-cap or hole closed with a plug that can be removed from the hole. Pouring paint from these openings can be challenging without a spout. Further, straining paint by pouring the paint through a separate strainer becomes messy.

### SUMMARY

An aspect of the specification provides a modular paint spout comprising: a hollow spout shaft comprising an insertion end and an oppositely disposed pouring end, the insertion end enabled for removable attachable insertion into a hole of a paint container, the pouring end enabled to direct paint pouring through the hollow spout shaft; a strainer member; and, a strainer retaining portion for enabling a strainer member to be removably retained by the hollow spout shaft such that the paint poured there through is filtered by the strainer member, wherein the strainer member extends from at least one of: the pouring end of the hollow spout shaft; and, the insertion end of the hollow spout shaft.

The strainer retaining portion can be located at one or more of: the insertion end, of the hollow spout shaft; the pouring end of the hollow spout shaft; and an interior surface of the hollow spout shaft.

The strainer retaining portion can comprise at least one of: a mechanism for removably attaching the strainer member to the hollow spout shaft; one or more grooves for receiving a retainer portion of the strainer member; one or more threads enabling the retaining portion of the strainer member to be removably screwed on the hollow spout shaft; and one or more clips enabling the retaining portion of the strainer member to be removably clipped on the hollow spout shaft.

The strainer retaining portion can comprise the insertion end adapted to accept a retaining portion of the strainer member such that the strainer member can be retained between the hollow spout shaft and the hole of the paint container.

A diameter of the hollow spout shaft can be one of decrease from the insertion end to the pouring end; increase from insertion end to the pouring end; and is about constant between the insertion end and the pouring end.

A diameter of the hollow spout shaft can be larger than a given diameter of the hole of the paint container, such that the hollow spout shaft widens from the insertion end.

The strainer retaining portion can be proximal to a pouring member at the pouring end when the straining portion extends from the pouring end of the hollow spout shaft, the pouring member for directing paint pouring through the hollow spout shaft.

The strainer retaining member and a cross-section of the strainer member can be circular and a diameter of the strainer member can compliments a diameter of the strainer retaining member.

The strainer retaining portion can comprise a circumferential groove at an interior surface of the hollow spout shaft for receiving a complimentary edge of the strainer member, such that the strainer member snaps into the groove.

The strainer member can comprise a retaining, portion for retaining a straining portion.

The strainer member can comprise one or more of: a rigid straining portion; a basket-shaped straining portion; a circular basket shaped straining portion; a dome shaped straining portion; a cube shaped straining portion; a rectangular shaped straining portion; a metal straining portion; a fabric straining portion; a nylon straining portion; a circular straining portion; and a non-circular straining portion.

The strainer member can be enabled to extend into the hole of the of paint container when the strainer member extends from the insertion end of the hollow spout shaft.

The paint spout can further comprise a threaded collar enabled to be screwed onto a threaded nipple of a first type of paint container for pouring paint there through, the threaded collar comprising an aperture there through comprising a diameter of a pouring hole of a second type of paint container, the insertion end of the hollow spout shaft removably attachable to the aperture and the pouring hole.

The paint spout can further comprise a cap enabled for removable attachment to the pouring end such that the hollow spout shaft can be sealed when attached to the first type of paint container or the second type of paint container

The strainer member can be one of a plurality of strainer members, each of the plurality of strainer members comprising a respective gauge enabled for straining at least one of a respective type of paint and a respective type of coating.

### BRIEF DESCRIPTIONS OF THE DRAWINGS

Implementations are described with reference to the following figures, in which:

FIG. 1 depicts a front perspective view of a paint spout, according to non-limiting implementations.

FIG. 2 depicts a bottom perspective view of the paint spout of FIG. 1, according to non-limiting implementations.

FIG. 3 depicts a top perspective view of the paint spout of FIG. 1, according to non-limiting implementations.

FIG. 4 depicts a bottom perspective view of the paint spout of FIG. 1, according to non-limiting implementations.

FIG. 5 depicts a cross-section of the paint spout of FIG. 3 through line A-A of FIG. 3, according to non-limiting implementations.

FIG. 6 depicts a perspective view of the cross-section of FIG. 4, according to non-limiting implementations.

FIG. 7 depicts a cross-section of the paint spout of FIG. 3 through line B-B of FIG. 3, according to non-limiting implementations.

FIG. 8 depicts a strainer member removably insertable in the hollow spout shaft of FIG. 1, according to non-limiting implementations.

FIG. 9 depicts a front perspective view of an alternative paint spout, according to non-limiting implementations.

FIG. 10 depicts a perspective view of a closing mechanism for attachment to the paint spout of FIG. 1, according to non-limiting implementations.

FIG. 11 depicts a front perspective view of a paint spout including a cap and a threaded adaptive collar, according to non-limiting implementations.

FIG. 12A depicts a perspective view of the threaded adaptive collar of FIG. 11, according to non-limiting implementations.

FIG. 12B depicts a cross-section of the threaded adaptive collar of FIG. 11, according to non-limiting implementations.

FIG. 13 depicts a perspective view of a paint spout removably attached to a 1 gallon paint can cover, according to non-limiting implementations.

FIG. 14 depicts a bottom perspective view of the cap of FIG. 11, according to non-limiting implementations.

FIG. 15 depicts a front perspective view of a paint spout, according to non-limiting implementations.

FIG. 16 depicts a bottom perspective view of the paint spout of FIG. 15, according to non-limiting implementations.

FIG. 17 depicts an exploded view of a paint spout, according to non-limiting implementations.

FIGS. 18 and 19 depict combinations of paint spout and a strainer member, according to non-limiting implementations.

FIG. 20 depicts an inverted strainer member inserted in an opening of a paint container, according to non-limiting implementations.

FIG. 21 depicts a strainer member, according to non-limiting implementations.

FIGS. 22 to 24 depict schematic cross-sections of strainer members, according to non-limiting implementations.

FIG. 25 depicts a front perspective view of a paint spout including an adaptive collar which attaches to paint spout using threads, according to non-limiting implementations.

FIG. 26 depicts a perspective view of a modular paint spout with a cap removed, and a strainer portion extending from an insertion end, according to non-limiting implementations.

FIG. 27 depicts an assembled side view of the modular paint spout of FIG. 27, with a partial cutaway of an optional threaded collar an insertion end of a hollow spout shaft showing attachment of a strainer portion to the hollow spout shaft and attachment of the optional threaded collar to the hollow spout shaft, according to non-limiting implementations.

FIG. 28 depicts an exploded view of the modular paint spout of FIG. 27, according to non-limiting implementations.

### DETAILED DESCRIPTION OF THE IMPLEMENTATIONS

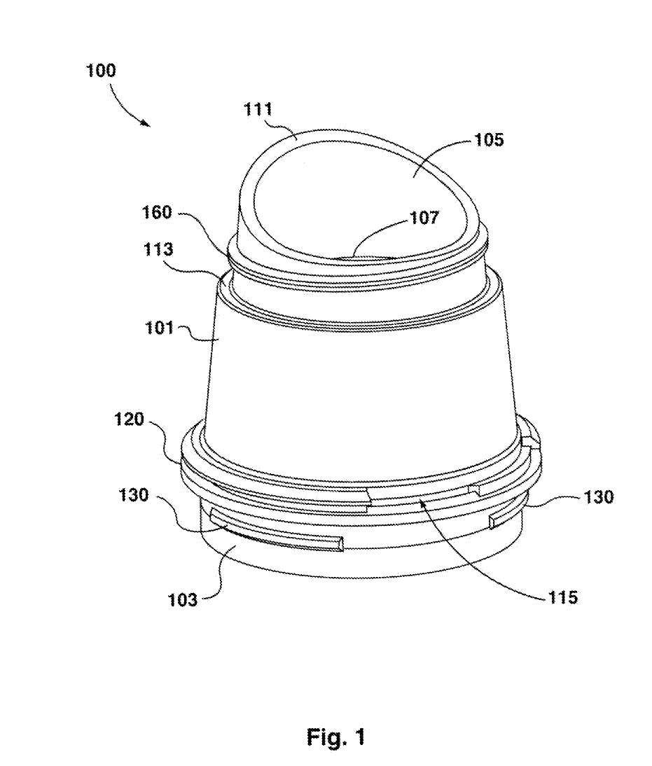

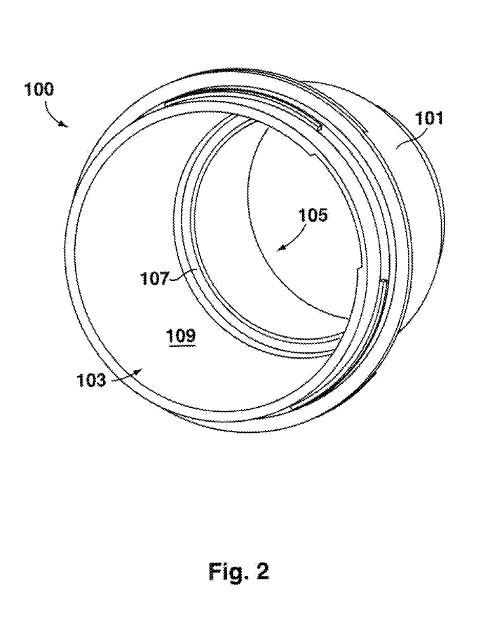

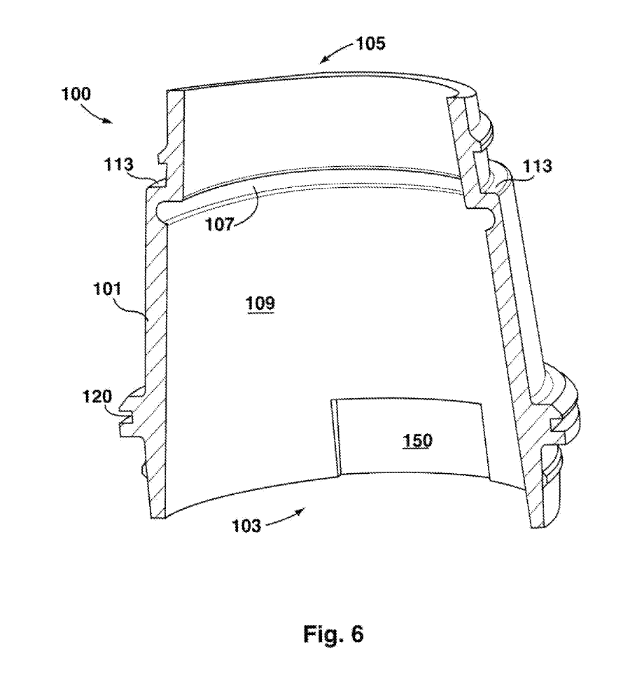

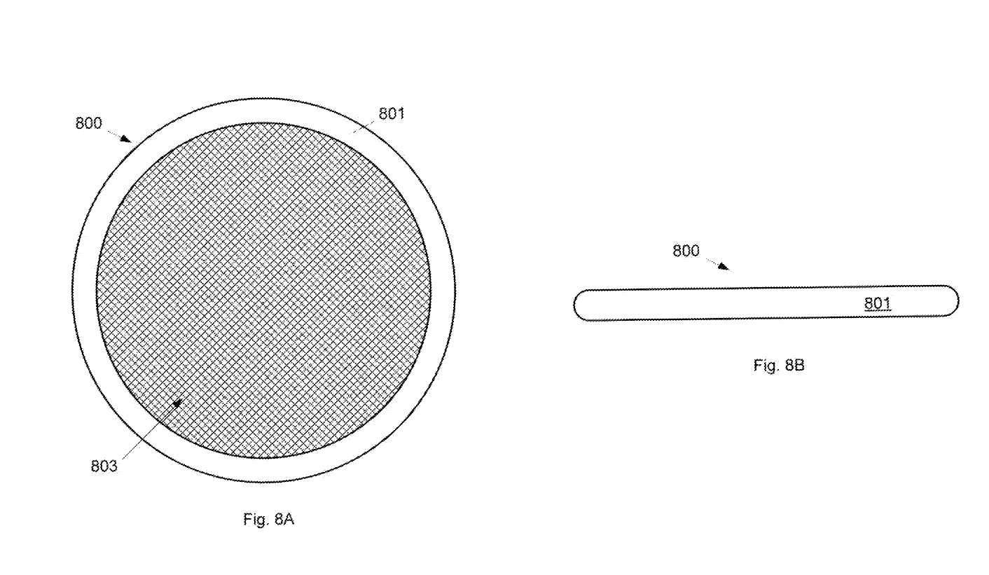

FIGS. 1-7 depict a paint spout 100, according to non-limiting implementations. Paint spout 100 comprises a hollow spout shaft 101 (also referred to hereafter as shaft 101) comprising an insertion end 103 and an oppositely disposed pouring end 105. Insertion end 103 is enabled for removable attachable insertion into a hole of a paint container, as will be described below. Pouring end 105 is enabled to direct paint pouring through shaft 101. Referring to FIGS. 2, 4, 5, 6 and 7, paint spout 100 further comprises a strainer retaining portion 107 at an interior surface 109 of shaft 101 for retaining a strainer member 800 (depicted in FIG. 8, according to non-limiting implementations) enabled for removable attachment to interior surface 109 such that paint poured there through is filtered by strainer member 800.

With reference to FIG. 8, strainer member 800 described below. In some implementations, strainer member 800 comprises an edge portion 801 that encompasses a filter portion 803 attached to edge portion 801, filter portion 803 for filtering at least one of a respective type of paint and a respective type of coating. It is appreciated that filter portion 803 can comprise any suitable filter, including but not limited to a mesh filter. Mesh filter can comprise any suitable mesh of any suitable gauge and any suitable material including but not limited to metals, nylon, plastics or the like.

In any event, in some implementations, edge portion 801 is enabled to snap into strainer retaining portion 107 which, for example, can comprise a circumferential groove for receiving edge 801 of strainer member 800, such that edge 801 of strainer member 800 snaps into strainer retaining portion 107 (e.g. the groove). Edge portion 801 can comprise any suitable material, such as metals, plastics, rubber, rubber-like material or the like such that edge portion can be snapped into strainer retaining portion 107 and then removed for cleaning and/or replacement. As such edge portion 801 can be flexible and/or deformable (while retaining its general shape), for insertion into and/or removal from strainer retaining portion 107.

In some implementations, strainer member 800 can be one of a plurality of strainer members, each of the plurality of strainer members (including strainer member 800) comprising a respective filter and/or a respective gauge enabled for straining at least one of a respective type of paint and a respective type of coating. In some implementations, each of paint spout 100 and strainer member 800 can be provided (e.g. sold) separately and assembled thereafter. In other implementations paint spout 100 and strainer member 800 can be provided as a kit, preassembled or unassembled. In yet further implementations, paint spout 100 and the plurality of strainer members, including strainer member 800, can be provided as a kit, unassembled or with one of the plurality of strainer members assembled with paint spout 100.

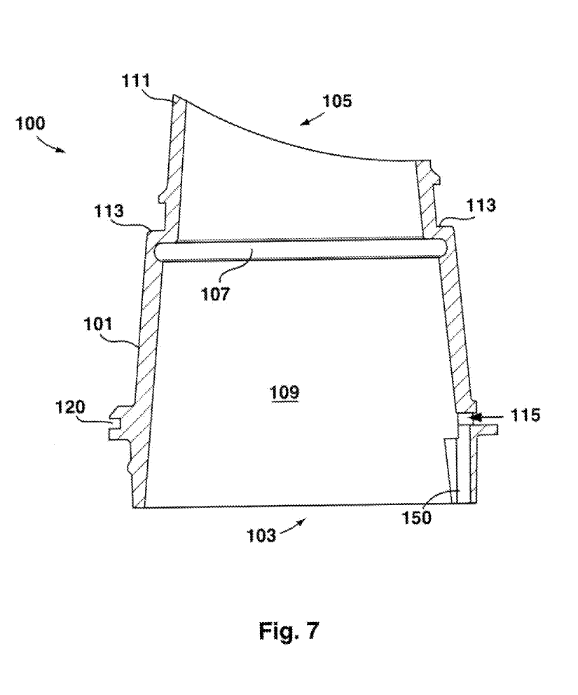

Returning to FIG. 7, in depicted implementations, strainer retaining portion 107 is proximal to a pouring member 111 at pouring end 105, though the location of strainer retaining portion 107 is generally understood to be non-limiting. It is generally appreciated that pouring member 111 comprises a lip for directing paint pouring through shaft 101.

Further, a shape of strainer member 800 is generally complimentary to a shape of strainer retaining portion 107 and in depicted implementations, both strainer retaining portion 107 and strainer member 800 are appreciated to be circular. In these implementations, a diameter of strainer member 800 compliments a diameter of strainer retaining member 107 and can be the same diameter of the inside of strainer retaining member 107, or slightly smaller to facilitate ease of snapping strainer member 800 in and out of strainer retaining, member 107.

Hence, paint spout 100 can include a removable built-in strainer (e.g. strainer portion 800) which can comprise circular disc like strainer which can be similar to what is found in a water faucet but enabled to snap into the diameter of shaft 101. The strainer is removable so that it can be at least one of washed, reused, disposed of and replaced. Different types of strainers can be sold separately and can be available in various gauges to accommodate different paints and coatings. In these implementations, paint spout 100 is modular, however in other implementations, a strainer can be permanently moulded into paint spout 100; in these latter implementations, the strainer can also be washable within paint spout 100.

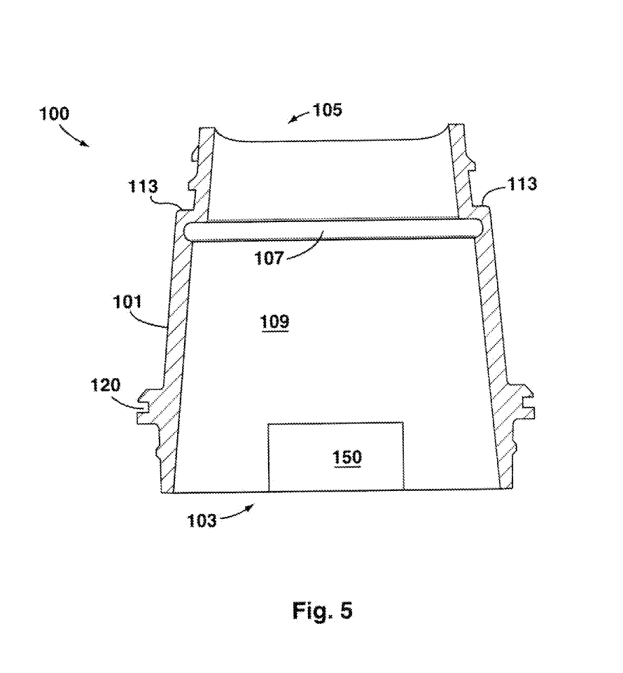

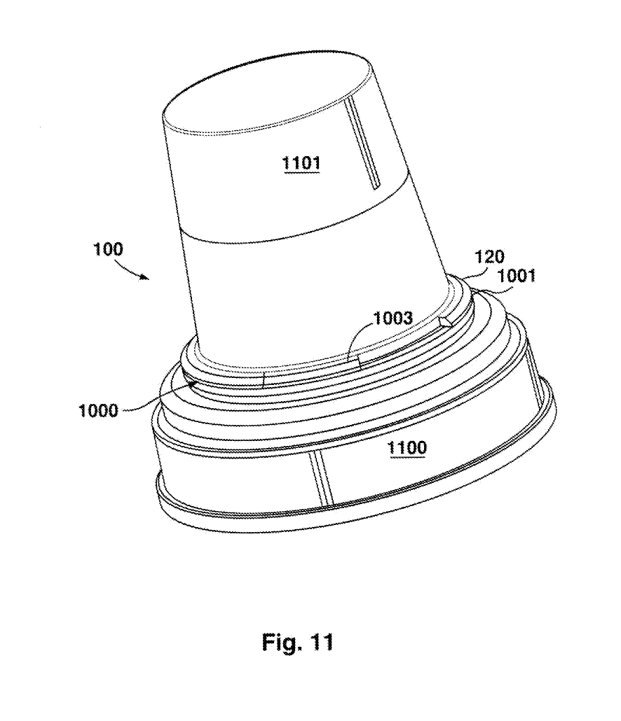

It is further appreciated, as depicted in FIGS. 5-7, that an upper surface of strainer retaining portion 107 can define an external ridge 113 of shaft 101, the external ridge 113 providing a surface against which a cap 1101 can be tightened to seal shaft 101, as described below with reference to FIG. 11.

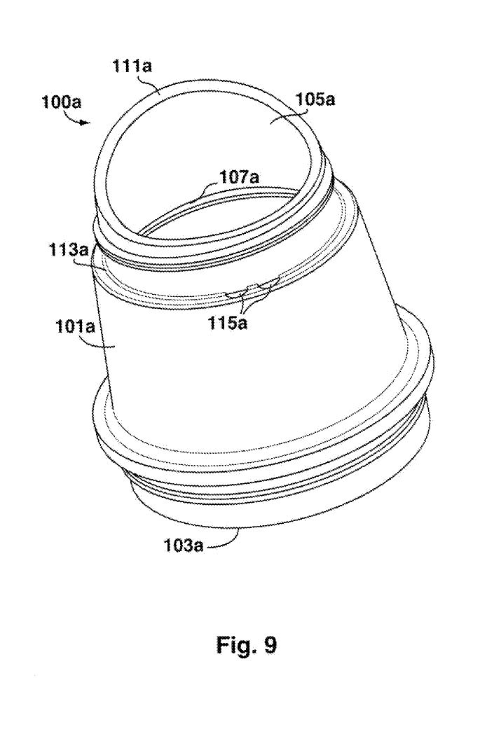

As depicted in FIGS. 1, and 7, in, some implementations, paint spout 100 comprises at least one vent 115 in a portion of shaft 101 opposite a pouring side of said shaft 101 (e.g. a side opposite pouring member 111), at least one vent 115 for enabling air to enter a paint container (note depicted) to which paint spout 100 is attached as paint is being poured through shaft 101. In some implementations, at least one vent 115 comprises an aperture in shaft 101. In some implementations, at least one vent 115 comprises an aperture in ridge 113 of shaft 101. For example, FIG. 9 depicts a paint spout 100a substantially similar to paint spout 100 with like elements having like numbers, however with an “a” appended thereto. However vents 115a comprise apertures in ridge 113a of shaft 101.

In some implementations, vents 115a can comprise passages that extend longitudinally (i.e. lengthwise) through shaft 101a to said insertion end 103a. For example, one or more vents (which can also be referred to as snorkels and/or air passages) can been built into the wall of shaft 101a to allow air to pass into a paint container for facilitated pouring (i.e. to accommodate air flow into the paint container). When cap 1101, described below, is screwed on over the shaft 101a, cap 1101 covers vents 115a keeping shaft 101a airtight and preventing air from getting into a paint container when paint spout 100a is attached thereto, whether it is a 5 or 1 gallon paint container of liquid (e.g. as described below). The air can be drawn in above strainer portion 800 so not to impede flow of liquid. Furthermore, while two vents 115a (and/or snorkels and/or air passages have been used in depicted implementations, the number of vents 115a (and/or snorkels and/or air passages is not be considered unduly limiting; hence other implementations can comprise one or more vents 115a (and/or snorkels and/or air passages). When vents 115a pass length-wise from ridge 113a to insertion end 103a, vents 115a can include respective ridges in the interior surface of wall that incorporates the air passages.

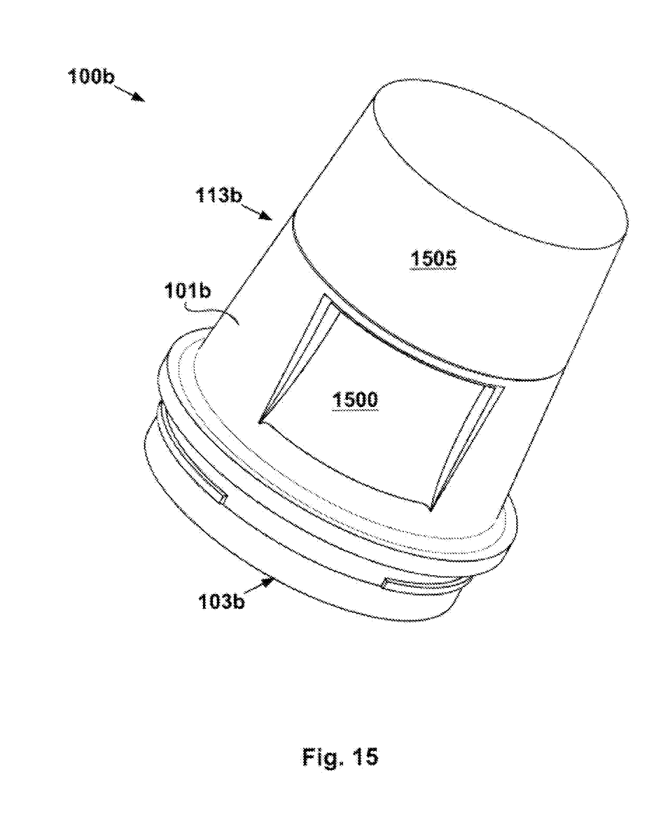

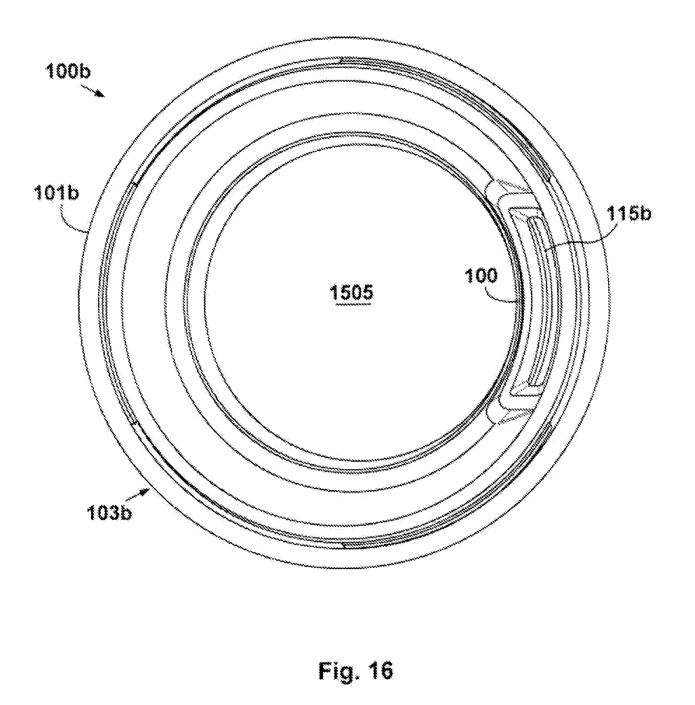

FIGS. 15 and 16, depicts a paint spout 100b, similar to paint spout 100 with like elements having like numbers, however with a “b” appended thereto. Paint spout 100b comprises a vent 115b which extends from insertion end 103b to ridge 113b through shaft 101b. The integration of vent 115b into shaft 101b causes a protrusion 1500 on shaft 101b, vent 115b further defined by walls 1600 extending from an interior of shaft 101b, as depicted in FIG. 16, vent 115b defined by protrusion 1500 and walls 1600. FIGS. 15 and 16 further depict a cap 1505 capping shaft 101b, and further sealing vent 115b at ridge 113b. In any event, any suitable vent in shaft 101 and/or shaft 101a and/or shaft 101b is within the scope of present implementations.

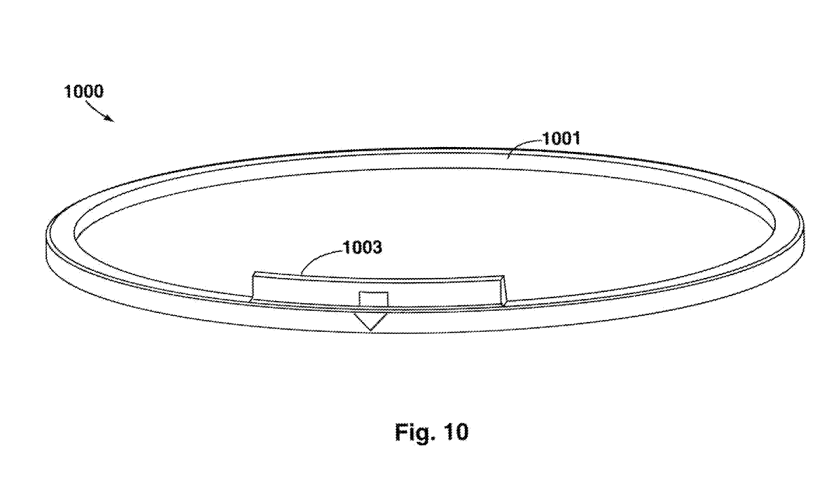

Returning to FIGS. 1, 4 and 7, in depicted non-limiting implementations, at least one vent 115 comprises a radial slit in shaft 101. Proximal at least one vent 115 is a retaining mechanism 120 (e.g. a circumferential track) for retaining a closing mechanism 1000 for opening and closing vent 115 (e.g. the radial slit) so that venting can be controlled and/or shaft 101 can be sealed when not in use, closing mechanism 1000 depicted in FIG. 10, according to non-limiting implementations. It is appreciated that retaining mechanism 120 is on an exterior surface of shaft 101, proximal to at least one vent. With reference to FIG. 10, closing mechanism 1000 comprises a ring 1001 circumferentially slideable in retaining mechanism 120. Ring 1001 is enabled to fit over shaft 101 and snap into retaining mechanism 120. Closing mechanism further comprises a cover 1003 extending from ring 1001 for covering vent 115 (eg. the radial slit) in a first position and exposes vent 115 (e.g. radial slit) in a second position as ring 1001 is rotated. For example, FIG. 11 depicts paint spout 100 with closing mechanism 1000 in a position that causes cover 1003 to cover vent 115 (hence vent 115 is not visible in FIG. 11), with ring 1001 retained in retaining mechanism 120. In some implementations, closing mechanism 1000 comprises an edge on cover 1003 for cleaning vent 115 (e.g. radial slit) of paint or other coating materials as closing mechanism 1000 is moved into a position that closes vent 115 (e.g. radial slit).

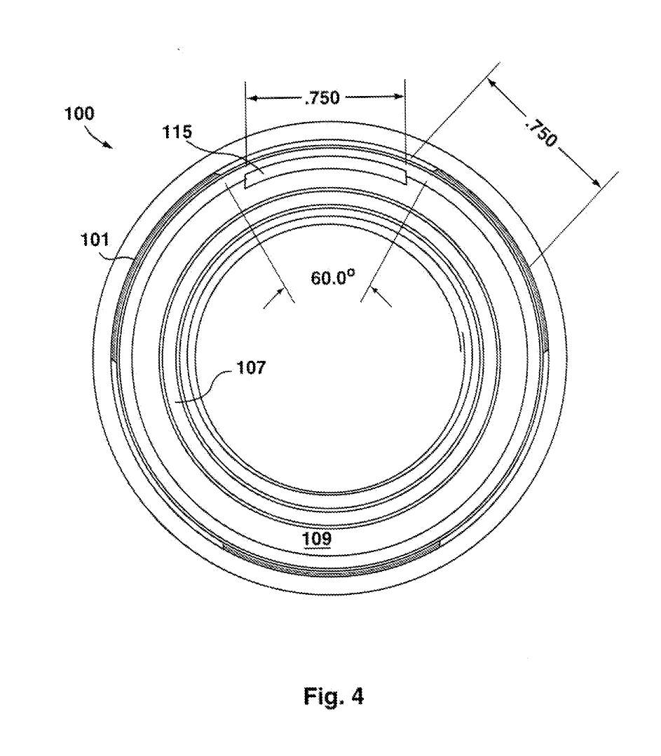

As depicted in FIG. 4, radial slit can comprise an angle of approximately 60° in shaft 101, and comprise length of approximately 0.75 inches, though the radial slit can range from approximately 10° to approximately 270°, and the length can range from approximately 0.01 inches to 2 inches. Furthermore, in some embodiments, vent 115 can comprise, pin-like holes.

Furthermore, as depicted in FIGS. 5, 6, and 7, in some implementations, radial slit can be formed by cut-out 150 of an interior surface 109 of shaft 101.

It is appreciated, however, that venting mechanisms are optional and that other paint spouts within the scope of present implementations do not include venting mechanisms other than the passage of air through the paint spout as paint is being poured therethrough.

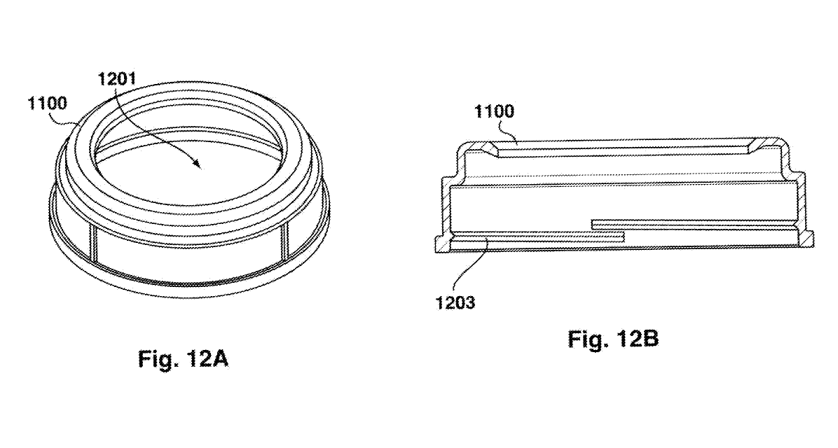

FIG. 11 also depicts a threaded collar 1100 enabled to be screwed onto a threaded nipple (e.g. a threaded male opening) of a first type of paint container for pouring paint there through. Threaded collar 1100 is further depicted in FIGS. 12A (in perspective) and 12B (in cross-section). In FIG. 12A, it is appreciated that threaded collar comprising an aperture 1201 there through comprising a diameter of a pouring hole of a second type of paint container (not depicted), insertion end 103 of hollow spout shaft 101 enabled for removable attachable insertion into aperture 1201 and pouring hole. For example, returning to FIG. 1, insertion end 103 can comprise at least one ridge 130, or any other suitable type of engagement mechanism, for engaging aperture 1201, for example by hooking under a rim of aperture 1201. As threads 1203 of threaded collar 1100 are enabled to screw onto the threaded nipple (e.g. a threaded male opening) of the first type of paint container and insertion end 103 can be removably attached to either threaded collar 1100 or the pouring hole of the second type of paint container, via insertion, paint spout 100 is thereby enabled for attachment to either the first type of paint container (by using threaded collar 1100) or the second type of paint container (by inserting insertion end 103 into the pouring hole).

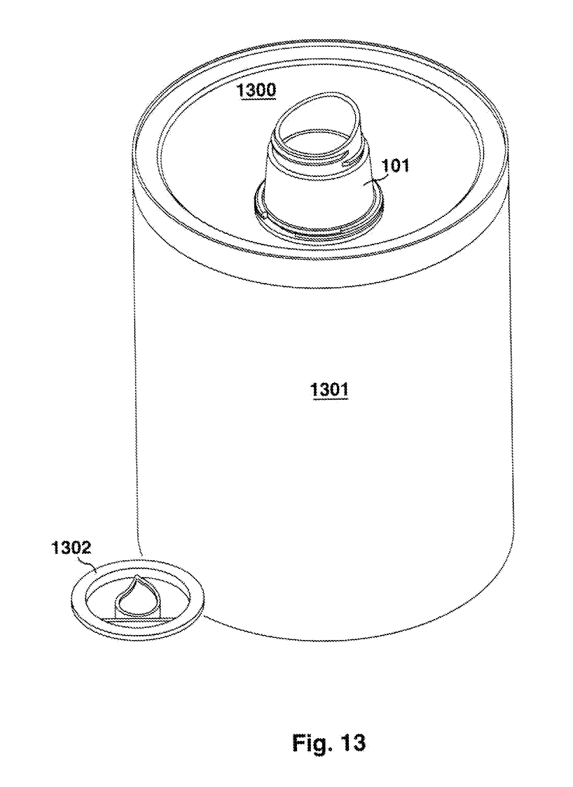

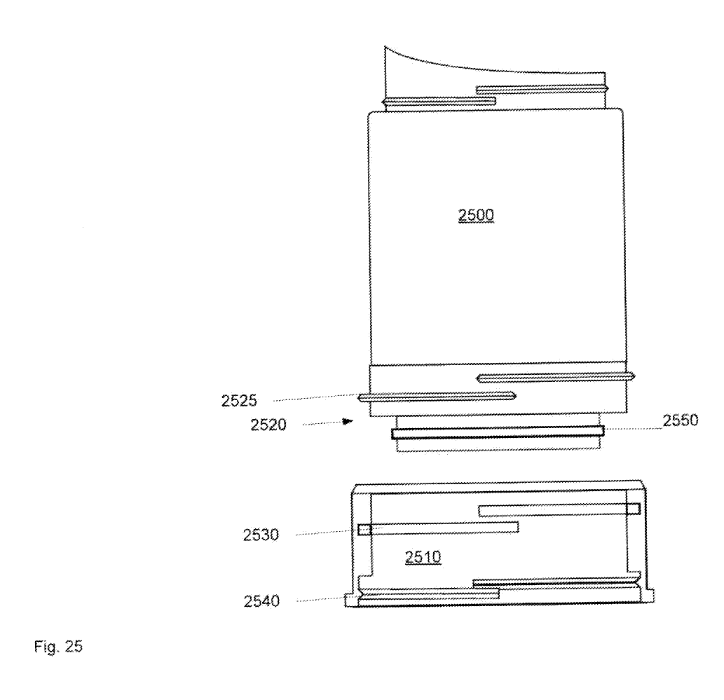

Attention is next directed to FIG. 25, which depicts a paint spout 2500 similar to paint spout 100h, and a partial cutaway view of a threaded collar 2510 similar to threaded collar 1100. However, in these implementations, paint spout 2500 comprises threads 2525 at, or adjacent to, an insertion end 2520 along the outside (e.g. a threaded male end), and threaded collar 2510 comprise complimentary threads 2530 on an interior surface (i.e. a threaded female collar) such that threaded collar 2510 can be screwed onto paint spout 2500 rather than snapped into place as with threaded collar 1100 and paint spout 100. Threaded collar 2510 further comprises a second set of threads 2540 similar to threads 1203, which enable threaded collar to screw onto a threaded nipple (e.g. a threaded male opening) of the first type of paint container, similar to threaded collar 1100. Similarly, paint spout 2500 can be removably attached to either threaded collar 2510 (e.g. via threads 2525) or the pouring hole of the second type of paint container, via insertion, for example via at least one ridge 2550 similar to at least one ridge 130. Hence, paint spout 2500 is thereby enabled for attachment to either the first type of paint container (by using threaded collar 2510) or the second type of paint container (by inserting insertion end 2520 including at least one ridge 2550 into the pouring hole). From FIG. 25 it is further appreciated that threads 2525 are on a portion of paint spout 2500 having an outer diameter similar to an inner diameter of threaded collar 2510 (and hence also similar to an opening of the first type of paint container), and that at least one ridge 2550 are on a portion of paint spout 2500 having an outer diameter similar to an opening of the second type of paint container. In other words, the diameter of insertion end steps down from a first diameter adjacent insertion end 2520, the first diameter similar to an inner diameter of threaded collar 2510 (and hence also similar to an opening of the first type of paint container), to a second diameter at insertion end 2520, the second diameter similar to an opening of the second type of paint container. In some implementation, paint spout 2500 can be inserted into an opening of a paint container cover 1300 (e.g. as depicted in FIG. 13), which is the subject of U.S. Provisional Patent Application 61/358,033 filed by the applicant on Jun. 24, 2010 and entitled “PAINT CONTAINER COVER” filed, again by removing threaded collar 2510 from paint spout 2500 and snapping insertion end 2520 of paint spout 2500 (including at least one ridge 2550) into an opening that is a similar size to the opening in the plug style 5 gallon paint container. As paint container cover 1300 is enabled to seal a 1 gallon paint container 1301, paint spout 100 can be used therewith to pour and strain paint from 1 gallon paint containers.

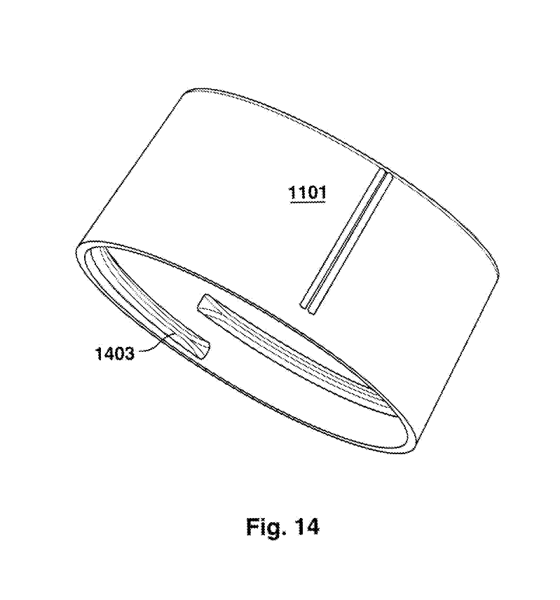

Returning to FIG. 11 and with further reference to FIG. 14, paint spout 100 can further comprise a cap 1101 enabled for removable attachment to pouring end 105 such that hollow spout shaft 101 can be sealed, for example when attached to first type of paint container or second type of paint container. In some implementations, as with paint spout 100a of FIG. 9, cap 1101 is further enabled to seal at least one vent 115a when cap 1101 is attached to hollow spout shaft 101a (e.g. cap 1101 can seal against ridge 113a, vents 115a being in ridge 113a).

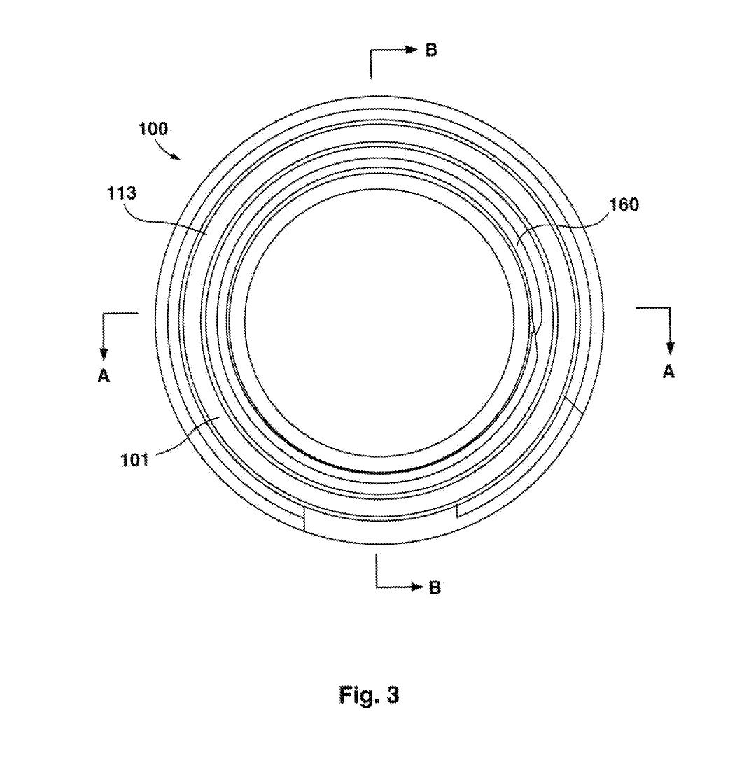

Furthermore, it is appreciated that shaft 101 can be threaded above ridge 113 (e.g. threads 160 in FIGS. 1 and 3) for receiving cap 1100, which also threaded (e.g. threads 1403 in FIG. 14) for attachment to shaft 101 as seen in FIG. 14. Furthermore both shaft 101 and cap 1101 can be tapered with a similar angle so that when cap 1101 is attached to shaft 101, the combination of cap 1101 and shaft 101 is stackable.

It is further appreciated that other types of caps are within the scope of present implementations, for example, a cap which snaps onto shaft 101 and/or a cap hinged to shaft 101.

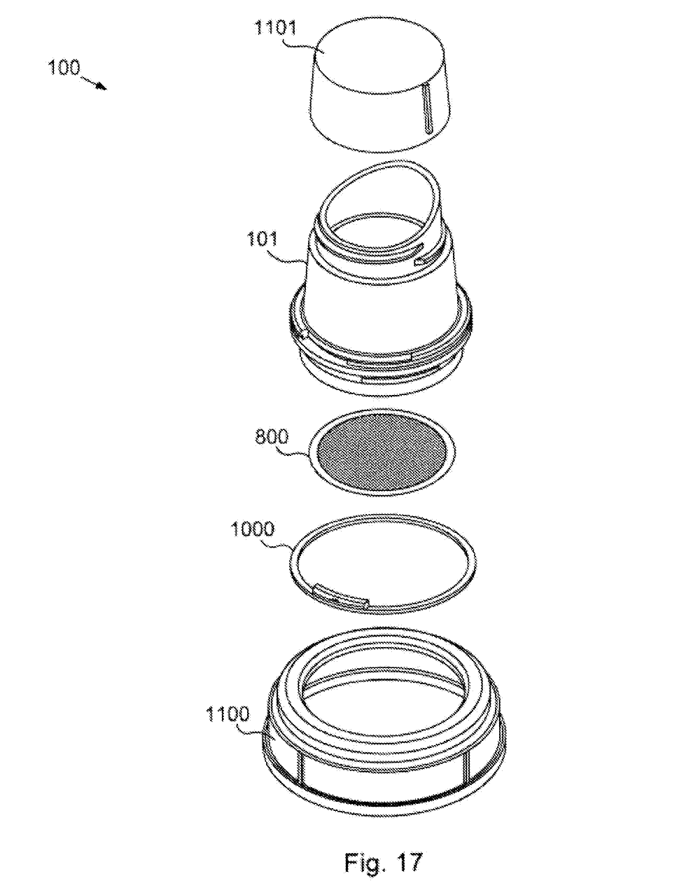

FIG. 17 depicts an exploded view of paint spout 100, comprising cap 1101 which removeably attached to shaft 101, which in turn can be removeably attached to threaded collar 1100. Strainer member 800 snaps inside shaft 101 and closing mechanism 1000 snaps onto the outside of shaft 101.

The first and second type of paint containers can each be 5 gallon paint containers, of which there are at least two types: one with a threaded nipple with a screw-off top, and one with a simple hole with a removable plug. Hence, paint spout 100 attaches to: threaded five gallon paint containers via threaded (adaptive) collar 1100; and plug style 5 gallon paint containers by removing the threaded (adaptive) collar 1100 from shaft 101 and inserting shaft 101 into the opening sealable by the plug. In some implementation, shaft 101 can be inserted into an opening of a paint container cover 1300 (e.g. as depicted in FIG. 13), which is the subject of U.S. Provisional Patent Application 61/358,033 filed by the applicant on Jun. 24, 2010 and entitled “PAINT CONTAINER COVER” filed, again by removing the threaded collar 1100 from shaft 101 and snapping shaft 101 into an opening that is a similar size to the opening in the plug style 5 gallon paint container. As paint container cover 1300 is enabled to seal a 1 gallon paint container 1301, paint spout 100 can be used therewith to pour and strain paint from 1 gallon paint containers. FIG. 13 further depicts a plug 1302 of paint container cover 1300, plug 1302 removed from an aperture in paint container cover 1300 so that shaft 101 can be inserted therein.

Paint spout 100 can comprise any suitable dimensions suitable for attachment to a corresponding paint container (or any other suitable type of container). For example insertion end 103 can comprise an exterior diameter of approximately 2.2 inches, though the diameter can range from approximately 0.5 inches to approximately 10 inches. Similarly, shaft 101 can be approximately 2.4 inches in length, though the height can range from approximately 1 inch to approximately 12 inches. The strainer retaining portion 107 can be approximately 0.1 inches in width, and hence a corresponding edge 801 of strainer member 800 can be approximately 0.1 inches thick, though the widths of strainer retaining portion 107 and the corresponding thickness of edge 801 can range from approximately 0.05 inches to approximately 0.5 inches. It is appreciated that in some implementations, filter portion 803 can be flat and/or in a pocket shape and/or a basket like shape and/or in a rounded shape (or any other suitable shape) of any suitable thickness and/or dimensions. For example, when filter portion 803 is not flat but three dimensional in shape, flow of paint or the like through filter portion 803 can be increased over flow through a flat filter.

The taper on shaft 101 and cap 1101 can each be approximately 5°, though the taper can range from approximately 0° to approximately 45°.

It is appreciated that other combinations of spout shafts and strainer members are within the scope of present implementations. For example, present implementations further provide a paint spout comprising: a hollow spout shaft comprising an insertion end and an oppositely disposed pouring end, the insertion end enabled for removable attachable insertion into a hole of a paint container, the pouring end enabled to direct paint pouring through the hollow spout shaft; and a strainer retaining portion for enabling a strainer member to be removably retained by the hollow spout shaft such that the paint poured there through is filtered by the strainer member. It is further appreciated that the strainer retaining portion can be located at one or more of the insertion end of the hollow spout shaft; the pouring end of the hollow spout shaft; and an interior surface of the hollow spout shaft.

Any suitable mechanism can be used to retain the strainer member. For example, the strainer retaining portion can comprise at least one of a mechanism for removably attaching the strainer member to the hollow spout shaft; one or more threads enabling a retaining portion of the strainer member to be removably screwed on the hollow spout shaft; and one or more clips enabling the retaining portion of the strainer member to be removably clipped on the hollow spout shaft. Alternatively, the strainer retaining portion can comprise the insertion end adapted to accept a retaining ring of the strainer member such that the strainer member can be retained between the hollow spout shaft and the hole of the paint container.

Furthermore, the hollow spout shaft can be any suitable shape. For example, a diameter of the hollow spout shaft, can generally decrease from insertion end to the pouring end. Alternatively, a diameter of the hollow spout shaft can generally increase from the insertion end to the pouring end. In further alternative implementations, a diameter of the hollow spout shaft can be generally constant between the insertion end and the pouring end. In yet further implementations, a diameter of the hollow spout shaft can be generally larger than a given diameter of the hole of the paint container, such that the hollow spout shaft widens from the insertion end.

The strainer member can be of any suitable shape and configuration. For example, the strainer member can comprise one or more of: a retaining portion for retaining a straining portion; a rigid straining portion; a dome shaped straining portion; a cube shaped straining portion; a rectangular shaped straining portion; a metal straining portion; a non-rigid straining portion; a fabric straining portion; a nylon straining portion; a circular straining portion; and a non-circular straining portion. It is further appreciated that the shape of the strainer member can be complimentary to an interior of the hollow spout shaft such that strainer member can reside therein. Furthermore, the strainer member can be enabled to one or more of: extend into the hollow spout shaft; extend from the hollow spout shaft extend into the hole of the of paint container.

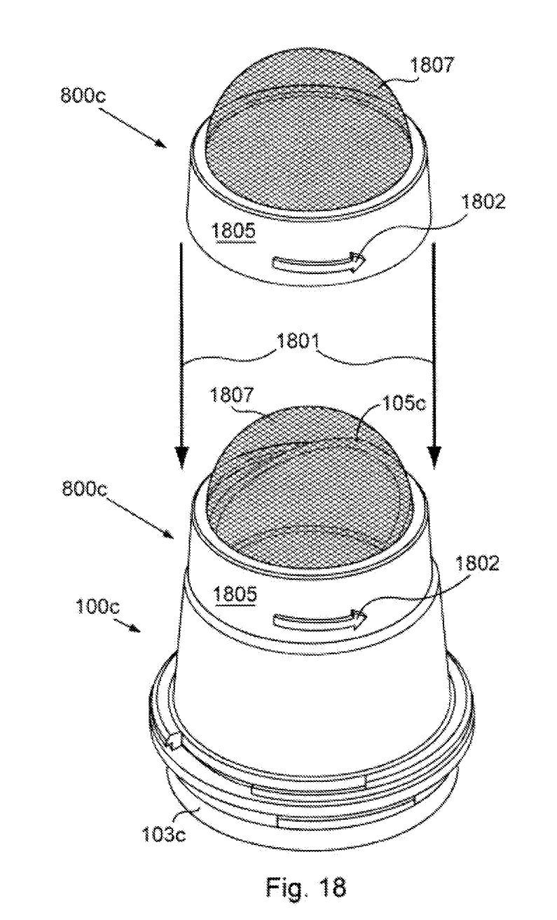

Various non-limiting implementations of a paint spout will now be described. For example, attention is directed to FIG. 18 which depicts a paint spout 100c, similar to paint spout 100, with like elements having like numbers, with however a “c” appended thereto. However paint spout 100c is adapted to receive a screw-on strainer member 800c at pouring end 105c. It is appreciated that FIG. 18 depicts strainer member 800c, both unattached, and attached to paint spout 100c, with arrows 1801 indicating a direction of attachment to paint spout 100c, and arrows 1802 indicating a direction for loosening strainer member 800c from paint spout 100c. In some implementations, arrow 1802 can be printed, embossed, etc, onto strainer member 800c to indicate a direction of loosening strainer member 800c; alternatively, an arrow indicating a direction of tightening can be provided.

In any event, it is appreciated that, while not depicted in FIG. 18, paint spout 100c further comprises threads (e.g. a strainer retaining portion) for receiving complimentary threads of strainer member 800c: in other words, strainer member 800c screws onto paint spout 100c at pouring end 105c. However, the mechanism for attaching strainer member 800c to paint spout 100c is not to be considered particularly limiting. For example, clips, or any other suitable mechanism, could be used to attach strainer member 800c to paint spout 100c.

It is further appreciated from FIG. 18 that strainer member comprises a retaining portion 1805, comprising a retaining ring, and a straining portion 1807, comprising a mesh in the shape of a circular basket, and extending from pouring end 105c of paint spout 100c when attached thereto. However, it is appreciated that straining portion 1807 can comprise any suitable shape and be rigid or flexible as desired. Furthermore, straining portion 1807 can comprise any suitable material, including but not limited to metals, nylon, plastics or the like.

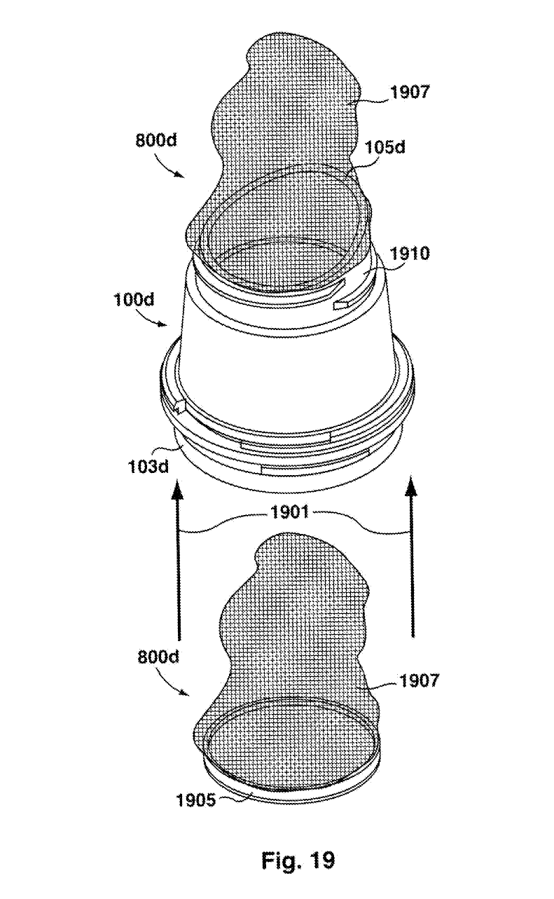

Attention is now directed to FIG. 19, which depicts a paint spout 100d, similar to paint spout 100c, with like elements having like numbers, with however a “d” appended thereto rather than a “c”. However paint spout 100d is adapted to receive an insertable strainer member 800d at insertion end 103d. It is appreciated that FIG. 19 depicts strainer member 800d both unretained, and retained by paint spout 100d, with arrows 1801 indicating a direction of retention to paint spout 100d.

In other words, strainer member 800d is inserted at insertion end 103d of paint spout and a retaining portion 1905 of strainer member 800d is retained by a bottom portion of insertion end 103d: hence, insertion end 103d comprises a straining retaining portion for retaining strainer member 800d to be removably retained at paint spout 100d. In other words, paint spout 100d retains strainer member 800d between insertion end 103d and the edge of a hole of a paint container into which insertion end 103d is inserted.

Further, a straining portion 1907 of strainer member 800d extends from retaining portion 1905 through paint spout 100d, out of pouring end 105d. It is appreciated that, in these implementations, strainer portion 1907 comprises a mesh bag, which is generally non-rigid, for example a mesh bag comprising any suitable material, including but not limited to fabric, nylon, plastics or the like.

It is appreciated that the shape and configuration of straining portion 1907 is generally non-limiting. For example, in other implementations, straining member 800d could comprise either of straining portion 1907 or straining portion 1807, and further the straining portion used with either of straining member 800c and 800d could be similar to either of straining portion 1907 or straining portion 1807.

It is yet further appreciated that paint spout 100d further comprises threads 1910 to which strainer member 800c could be attached. Hence, paint spout 100d could be used with strainer member 800c, strainer member 800d and/or both strainer member 800c and strainer member 800d.

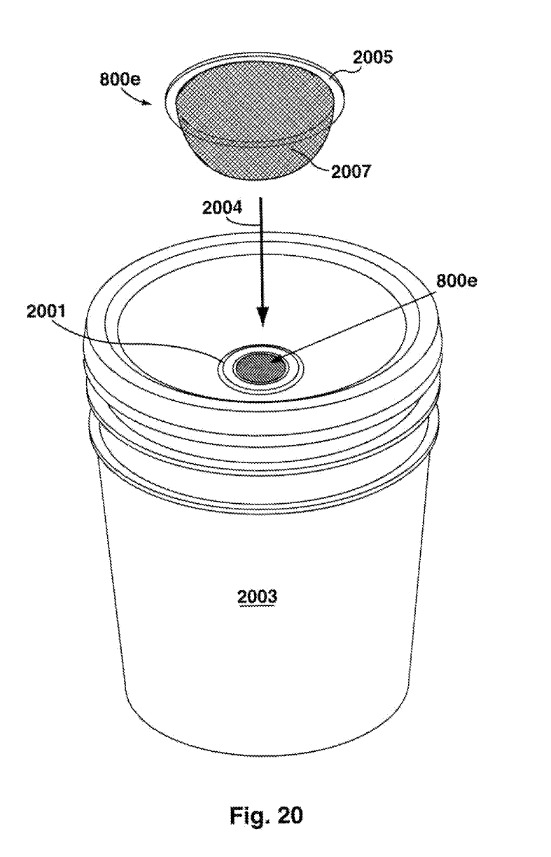

Attention is now directed to FIG. 20 which depicts a strainer member 800e inserted into a hole 2001 (i.e. an opening) 2001 of a paint container 2003; FIG. 20 further depicts strainer member 800e prior to insertion into hole 2001 with arrow 2004 showing strainer member 800e being inserted into hole 2001. From FIG. 20, it is appreciated that strainer member 800e comprises a retainer portion 2005 similar to retainer portion 1907, and a strainer portion 2007 similar to retainer portion 1807. It is further appreciated that, while not depicted at least one of modular paint can spout 100c and modular paint can spout 100d can then be inserted into hole 2001, the corresponding insertion end 103c or 103d retaining strainer member 800e in hole 2001. It is further appreciated that, in these implementations, strainer member 800e comprises an inverted basket that extends from the bottom of insertion end 103c or 103d. It is appreciated that strainer member 800e, as depicted, initially rests on a lid of paint container 2003; however, in other implementations, strainer member 800e further attaches to paint spout 100d using any suitable mechanism, including but not limited to internal threads, a tongue/groove mechanism or any other suitable attachment mechanism.

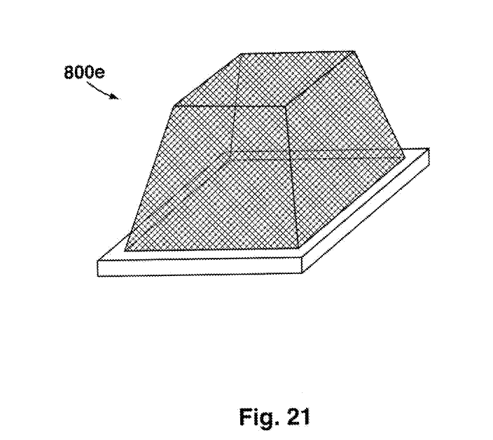

It is appreciated that while strainer members described heretofore have all been generally circular and/or included generally circular retainer portions, a given strainer member can be of any suitable shape, and is not limited to circular strainers. For example, FIG. 21 depicts a strainer member 800f that is generally a cube shape (and hence a basket with any suitable flexibility). It is appreciated that, while not depicted, a corresponding paint spout would be complimentary to strainer member 800e such that at least one end of the corresponding paint spout would be a complimentary shape to retain strainer member 800e.

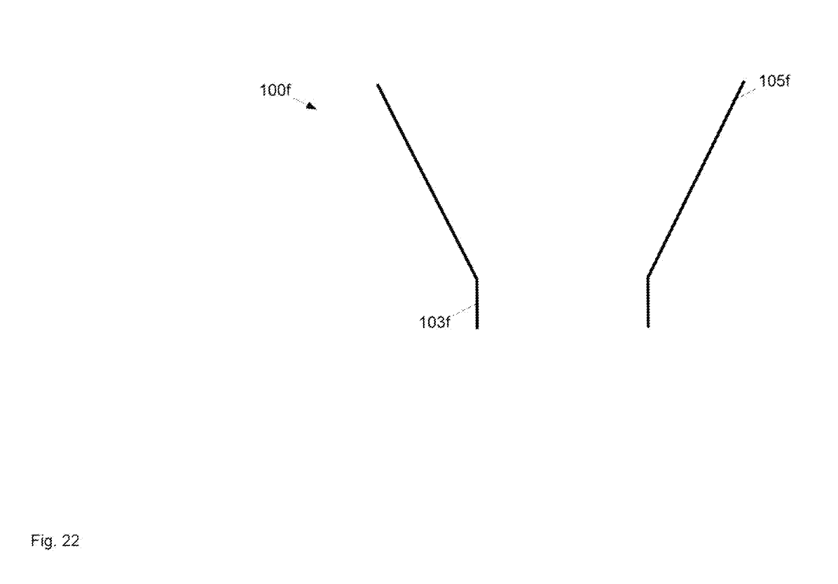

It is yet further appreciated that that while paint spouts described heretofore have all had diameters which decrease from the insertion end to the pouring end, a given paint spout can be of any suitable shape. For example, FIG. 22 depicts a paint spout 100f in schematic cross section to generally show that a diameter of paint spout 100f linearly increases from an insertion end 103f to a pouring end 105f. Such an increase in diameter can improve the flow of paint through paint spout 100f. While details of paint spout 100f are not depicted, it is generally appreciated that paint spout 1001 further comprises a strained retainer member for removably retaining a strainer member. For example, other than the increasing diameter, paint spout 100f can be generally similar to any of paint spouts 100, 100a, 100b, 100c, 100d.

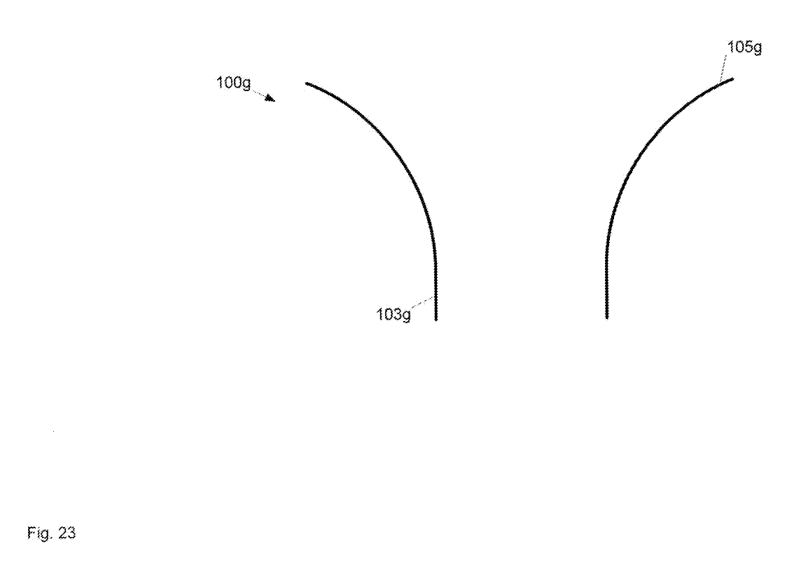

Similarly, FIG. 23 depicts a paint spout 100g in schematic cross section to generally show that a diameter of paint spout 100g increases from an insertion end 103g to a pouring end 105g in a concave manner. Such an increase in diameter can improve the flow of paint through paint spout 100g. While details of paint spout 100g are not depicted, it is generally appreciated that paint spout 100g further comprises a strained retainer member for removably retaining a strainer member. For example, other than the increasing diameter, paint spout 100g can be generally similar to any of paint spouts 100, 100a, 100b, 100c, 100d.

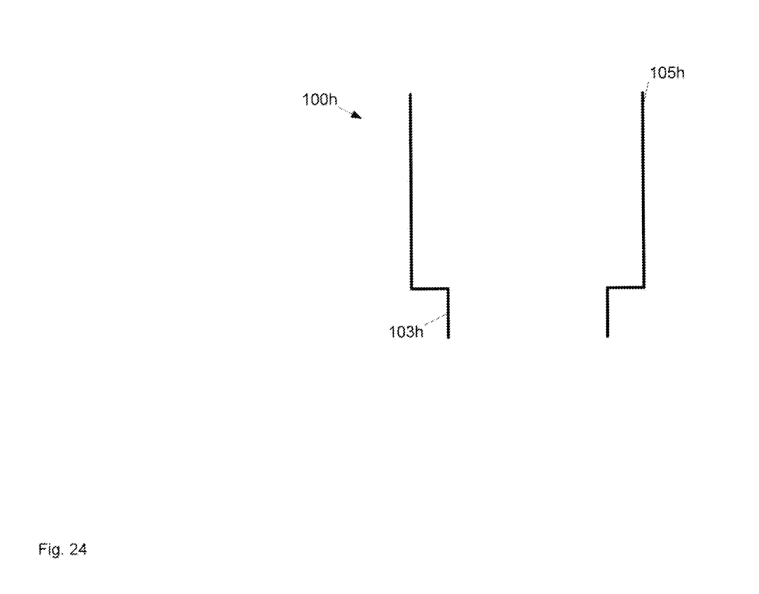

FIG. 24 depicts a paint spout 100h in schematic cross section to generally show that a diameter of paint spout 100h increases after an insertion end 103h, but is generally straight otherwise to a pouring end 105h. Such a step-wise increase in diameter after the insertion end 103h can improve the flow of paint through paint spout 100h. While details of paint spout 100h are not depicted, it is generally appreciated that paint spout 100h further comprises a strained retainer member for removably retaining a strainer member. For example, other than the increasing diameter, paint spout 100h can be generally similar to any of paint spouts 100, 100a, 100b, 100c, 100d.

It is furthermore appreciated that the diameter of pouring ends 105f, 105g, 105h can range from approximately 1 inch to approximately 5 inches, but that the degree of flaring and/or increase in diameter is not to be considered particularly limiting.

It is further appreciated that, in some implementations, a diameter of a paint spout can be the same from an insertion end to a pouring end; in other words, the diameter of such a paint spout can be similar to a diameter of an opening of a paint container into which the paint spout is to be inserted. For example a diameter of an opening (i.e. hole) of a 5 gallon paint container in North America is approximately 2 inches; hence the diameter of a corresponding straight walled paint spout can also be approximately 2 inches. However, the opening can be different in different jurisdictions, and a given straight walled paint spout can be adapted accordingly.

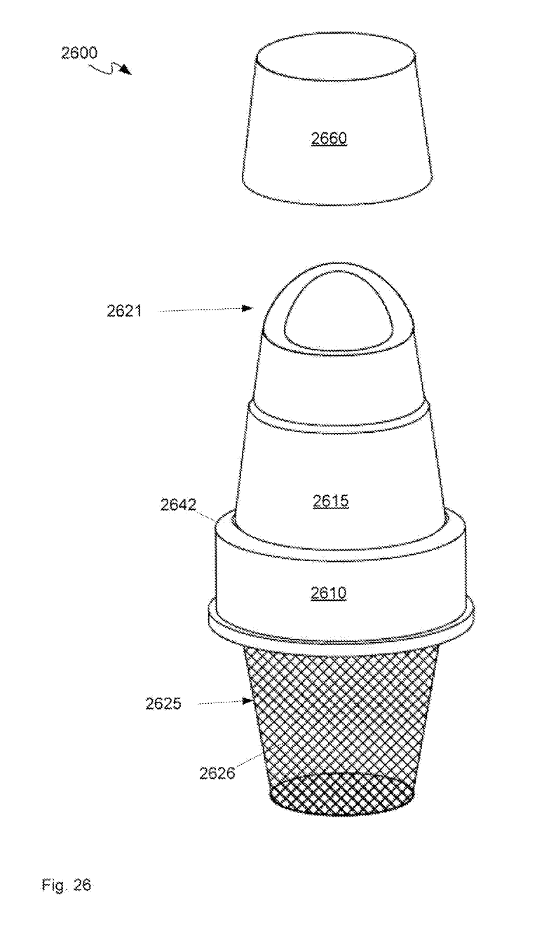

Attention is next directed to FIGS. 26, 27 and 28, which respectively depict a paint spout 2600 in a perspective and partly exploded view; an assembled and partial cutaway view, and an exploded view. Paint spout 2600 is generally similar to spout 100. Hence spout 2600 comprises: an optional threaded collar 2610; and a hollow spout shaft 2615 comprising an insertion end 2620 and an oppositely disposed pouring end 2621, insertion end 2620 enabled for removable attachable insertion into an aperture of a first type of paint container, and pouring end 2621 enabled to direct paint pouring through hollow spout shaft 2610.

Spout 2600 further comprises a strainer member 2625 comprising a strainer portion 2626 and a retainer portion 2630. Strainer portion 2626 is similar to strainer portion 1807 of FIG. 18, however, strainer portion 2626 comprises a frustum shaped basket (of a rigid mesh filter of any suitable material); further, strainer member 2625 extends from insertion end 2620 of hollow spout shaft 2615 (rather than pouring end 2621, as with strainer portion 1807 of FIG. 18). Retainer portion 2630 comprises a circumferential rigid lip of material at on an open end of strainer portion 2626. Retainer portion 2630 can also extend around one or more portions of open end of strainer portion 2626. Further retainer portion can comprise any comprise any suitable material, such as metals, plastics, rubber, rubber-like material or the like such that retainer portion 2630 can be snapped into a strainer retaining portion 2627 of hollow spout shaft 2615, such that strainer portion 2625 can be removed for cleaning and/or replacement.

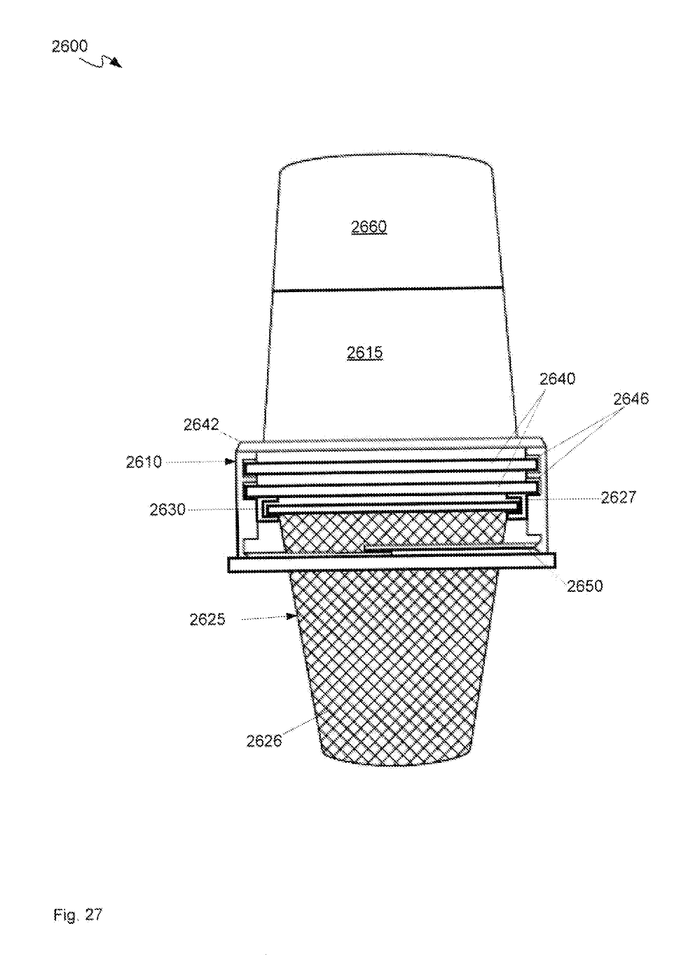

Hence, spout 2600 further comprises a strainer retaining portion 2627 (see FIG. 27) along on inside wall of hollow spout shaft 2615, strainer retaining portion 2627 enabling strainer member 2625 to be removably retained by hollow spout shaft 2615 such that the paint poured there through is filtered by strainer portion 2626

Strainer retaining portion 2627 is generally similar to strainer retaining portion 107, hence strainer retaining portion can comprise a circumferential groove on an inside surface of hollow spout shaft 2615 for receiving a retainer portion 2630 of strainer member 2625, such that retainer portion 2630 of strainer member 2625 snaps into strainer retaining portion 2627 (e.g. the groove). Indeed, details of the retaining of strainer retaining portion 2627 retaining retainer portion 2630 of strainer member 2625 are depicted in FIG. 27 in partial cutaway view. In other words, retainer portion 2630 removably “snaps” into strainer retaining portion 2627, such that strainer member 2625 can be removed for cleaning and/or so that a new strainer member (e.g. similar to strainer member 2625, but new and/or fresh, and/or with a different mesh gauge).

It is further appreciated that optional threaded collar 2630 is removably attachable to hollow spout shaft 2615 via at least one ridge 2640 (two are depicted in non-limiting implementations) located proximal insertion end 2620. At least one ridge 2640 can be removably retained by both an aperture of a paint container, as described above with reference to ridge 130, and by threaded collar 2610, such that threaded collar 1610 can be used to adapt spout 2600 to a paint container of a second type. It is appreciated that a paint container of a first type comprises a paint container with a simple aperture to pour paint there from, while a paint container of a second type comprises a paint container with a threaded nipple extending from an aperture.

Hence, without threaded collar, strainer member 2625 can be removably inserted into hollow spout shaft 2615 and insertion end 2620 can be inserted into an aperture of the first type of paint container with strainer portion 2615 extending towards and/or through the aperture.

However, for paint containers of the second type, threaded collar 2610 can be attached to hollow spout shaft 2615 by inserting insertion end 1620 of hollow spout shaft 2615 into an aperture of threaded collar 2610, which is of similar diameter to apertures of the paint container of the first type. Threads 2650 of threaded collar 2610 can be used to screw the combination of hollow spout shaft 2615/threaded collar 2610 onto the threaded nipple of the paint container of the second type, with strainer portion 2615 extending towards and/or through the aperture of the paint container of the second type.

In attaching hollow spout shaft 2615 to threaded collar 2610, at least one ridge 2640 is retained either by an internal circumference of lip 2642 of threaded collar 2610 or, as depicted, at least one retaining portion 2646 of threaded collar 2610 (e.g. at least one groove complimentary to at least one ridge 2640: two grooves are depicted). Indeed, details of the retaining of at least one retaining portion 2646 retaining at least one ridge 2640 of hollow spout shaft 2615 are depicted in FIG. 27 in partial cutaway view: each at least one ridge 2640 removably “snaps” into at least one retaining portion 2646 (which are complimentary to at least one ridge 2640), such that threaded collar 2610 can be added and/or removed from hollow spout shaft 2615. When threaded collar 2610 is on hollow spout shaft 1615, threads 2650 along an internal surface of threaded collar 2610 can be used to screw hollow spout shaft 2615 onto the threaded nipple of the paint container of the second type.

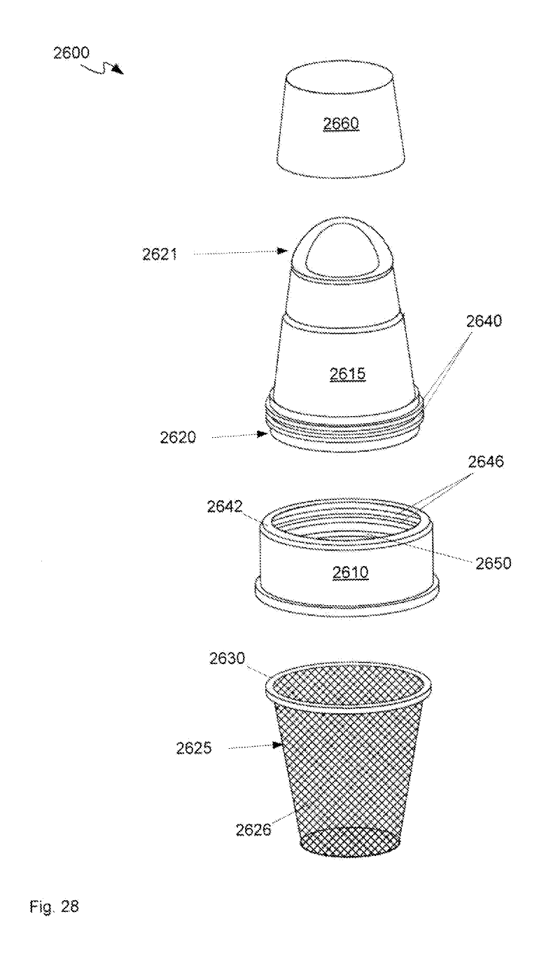

It further appreciated that spout 2600 can further comprise an optional cap 2660, similar to cap 1101, which can attach to pouring end 2621 of hollow spout 2615 either using one or more of a threaded mechanism, as with cap 1101, friction, and any other suitable mechanism. It is appreciated that cap 2660 is depicted as unattached in FIGS. 26, 28, and attached in FIG. 27.

It is yet further appreciated that while strainer portion 2626 is depicted as a frustum shaped basket in FIGS. 26-28, in other implementations, strainer portion 2626 can be of any other suitable shape, including, but not limited to, a circular basket, similar to strainer portion 1807 of FIG. 18.

Further, while strainer member 2625 attaches to hollow spout shaft 2615 via a snapping mechanism (i.e. at least one ridge 2640 removably “snaps” into complimentary at least one retaining portion 2646), in other implementations strainer member 2625 can screw into hollow spout shaft 2615 via complimentary threads on both strainer member 2625 and hollow spout shaft 2615 (e.g retainer portion 2630 is replaced with a collar having external threads, which screw into threads internal to hollow spout shaft 2615).

It is yet further appreciated that all variations and alternative features described herein can be used with any suitable paint spout described herein. For example, an insertion end of any of paint spouts 100-100h, 2600 can be adapted to include threads to complimentary to threaded collar 2510, any of paint spouts 100-100h, 2500, 2600 can comprise venting mechanisms and/or capping mechanisms. In particular, any of paint spouts 100-100h, 2500, 2600 can be suitably adapted for modular use with different gauges and/or types of paint strainer members described herein, or can alternatively be adapted to permanently mould a given strainer member therein such that an integrated paint spout/strainer member combination is provided.

Hence, described herein are various combinations of paint spouts and strainer members, which can be retained by the paint spout, in any suitable manner, to conveniently provide solutions for simultaneously pouring and straining, paint from a paint container.

Persons skilled in the art will appreciate that there are yet more alternative implementations and modifications possible for implementing the implementations, and that the above implementations and examples are only illustrations of one or more implementations. The scope, therefore, is only to be limited by the claims appended hereto.

What is claimed is:

1. A modular paint spout comprising:
a hollow spout shaft comprising an insertion end and an oppositely disposed pouring end, the insertion end enabled for removable attachable insertion into a hole of a paint container, the pouring end enabled to direct paint pouring through the hollow spout shaft;
a strainer member; and,
a strainer retaining portion for enabling a strainer member to be removably retained by the hollow spout shaft such that the paint poured there through is filtered by the strainer member,
wherein the strainer member extends from at least one of:
the pouring end of the hollow spout shaft; and,
the insertion end of the hollow spout shaft.

2. The modular paint spout of claim 1, wherein the strainer retaining portion is located at one or more of
the insertion end of the hollow spout shaft;
the pouring end of the hollow spout shaft; and
an interior surface of the hollow spout shaft.

3. The modular paint spout of claim 1, wherein the strainer retaining portion comprises at least one of:
a mechanism for removably attaching the strainer member to the hollow spout shaft;
one or more grooves for receiving a retainer portion of the strainer member;
one or more threads enabling the retaining portion of the strainer member to be removably screwed on the hollow spout shaft; and
one or more clips enabling the retaining portion of the strainer member to be removably clipped on the hollow spout shaft.

4. The modular paint spout of claim 1, wherein the strainer retaining portion comprises the insertion end adapted to accept a retaining portion of the strainer member such that the strainer member can be retained between the hollow spout shaft and the hole of the paint container.

5. The modular paint spout of claim 1, wherein a diameter of the hollow spout shaft one of:
decreases from the insertion end to the pouring end;
increases from insertion end to the pouring end; and
is about constant between the insertion end and the pouring end.

6. The modular paint spout of claim 1, wherein a diameter of the hollow spout shaft is larger than a given diameter of the hole of the paint container, such that the hollow spout shaft widens from the insertion end.

7. The modular paint spout of claim 1, wherein the strainer retaining portion is proximal to a pouring member at the pouring end, when the straining portion extends from the pouring end of the hollow spout shaft, the pouring member for directing paint pouring through the hollow spout shaft.

8. The paint spout of claim 1, wherein the strainer retaining member and a cross-section of the strainer member are circular and a diameter of the strainer member compliments a diameter of the strainer retaining member.

9. The paint spout of claim 1, wherein the strainer retaining portion comprises a circumferential groove at an interior surface of the hollow spout shaft for receiving a complimentary edge of the strainer member, such that the strainer member snaps into the groove.

10. The paint spout of claim 1, wherein the strainer member comprises a retaining portion for retaining a straining portion.

11. The paint spout of claim 1, wherein the strainer member comprises one or more of: a rigid straining portion; a basket-shaped straining portion; a circular basket shaped straining portion; a dome shaped straining portion; a cube shaped straining portion; a rectangular shaped straining portion; a metal straining portion; a fabric straining portion; a nylon straining portion; a circular straining portion; and a non-circular straining portion.

12. The paint spout of claim 1, wherein the strainer member is enabled to extend into the hole of the of paint container when the strainer member extends from the insertion end of the hollow spout shaft.

13. The paint spout of claim 1, further comprising a threaded collar enabled to be screwed onto a threaded nipple of a first type of paint container for pouring paint there through, the threaded collar comprising an aperture there through comprising a diameter of a pouring hole of a second type of paint container, the insertion end of the hollow spout shaft removably attachable to the aperture and the pouring hole.

14. The paint spout of claim 1, further comprising a cap enabled for removable attachment to the pouring end such that the hollow spout shaft can be sealed when attached to the first type of paint container or the second type of paint container

15. The paint spout of claim 1, wherein the strainer member is one of a plurality of strainer members, each of the plurality of strainer members comprising a respective gauge enabled for straining at least one of a respective type of paint and a respective type of coating.
